(19) United States
(12) Patent Application Publication
(10) Pub. No.: US 2016/0358280 A1
(43) Pub. Date: Dec. 8, 2016

(54) COMPUTERIZED SYSTEM AND METHOD FOR PROVIDING ENHANCED HEALTH BENEFITS

(71) Applicants: Joe Paul Woods, Louisville, KY (US); Elizabeth Tyra Gerlach Hilliard, Franklin, WI (US)

(72) Inventors: Joe Paul Woods, Louisville, KY (US); Elizabeth Tyra Gerlach Hilliard, Franklin, WI (US)

(73) Assignee: HUMANA INC., Louisville, KY (US)

(21) Appl. No.: 12/965,286

(22) Filed: Dec. 10, 2010

(51) Int. Cl. G06Q 50/00

(52) U.S. Cl. CPC G06Q 50/22

(57) ABSTRACT

A computerized system and method for enhancing benefits for members of a health benefits plan. The system and method target behavioral change by integrating personal engagement participation and rewarding individuals that commit to healthy lifestyle choices. The computerized system and method comprises an enrollment process that serves a starting point for determining a consumer's wellness, identifying tools and resources to increase the consumer's wellness, and applying incentives to encourage participation in wellness activities. Consumer enrollment data is stored in a shared repository that also tracks the consumer's participation in wellness activities and to determine eligibility for enhanced plan benefits. Enhanced plan benefits may include increased and/or expanded coverage for primary care and specialty care office visits, and/or reduced co-pays for office visits and emergency room or urgent care visits. Other aspects of the benefit plan may be modified once a member qualifies for enhanced plan benefits.

### CROSS-REFERENCE TO RELATED APPLICATIONS

None.

### BACKGROUND OF THE INVENTION

Most health insurance plans charge people that engage in healthy behaviors the same amount as those who do not. Although some individuals may be personally motivated to engage in healthy behaviors, health insurance companies typically do not consider whether external factors, such as differences in premiums and benefit levels, may influence health behaviors.

A consumer survey conducted in 2008 revealed that of 3,000 Americans surveyed:
83% expressed interest in participating in a wellness program offered by their employer, insurance company, or health plan that would entitle them to reduced premiums or lower co-pays; and
55% expressed interest in tools that would help them assess, monitor or manage their health.

In addition, one in two surveyed consumers reported taking preventive measures to reduce their need for healthcare.

A second annual consumer survey conducted recently found that consumers want resources to pursue wellness and healthy living. Consumers place high value on healthiness and want resources to assist them in changing their lifestyles. Resources include having access to tools and products that support improve lifestyles and motivation with incentives. It was noted that one in five participated in a wellness program in 2009 (up from 2008). More than half, however, said they would participate in a wellness program if given a financial incentive. Though consumers seem willing to participate in chronic care management programs without financial incentives, three out of five consumers with chronic conditions reported that financial penalties would increase their adherence to their chronic treatment regimen.

Consumerism in the healthcare arena is becoming more complex as behaviors, attitudes, and unmet needs continue to evolve. Congress has taken note of this complexity in the healthcare industry and is actively pursuing solutions as part of its healthcare reform package. Two solutions to reduce rising medical costs that are moving to the forefront are preventive services and introduction of workplace wellness programs sponsored by employers. Consulting firms are also anticipating the importance of healthcare reform and are actively surveying healthcare consumers to gain insights. Recent studies suggest that a growing number of consumers want to be actively engaged and are interested in programs, tools, and resources to assist with their overall health improvements. Few such programs, tools, or resources exist. There is a need for a health insurance plan that supports consumer interest in wellness and healthy living resources and that provides financial incentives for participation in wellness and healthy living programs.

### SUMMARY OF THE INVENTION

The present disclosure describes a system and method for targeting behavioral change by integrating personal engagement participation and rewarding, using health plan benefits, individuals that commit to healthy lifestyle choices in pursuit of wellness. The present disclosure describes a health insurance plan that costs less for those individuals that commit to responsible, healthy behaviors. The disclosed system and method addresses three important needs: wellness; tools that promote health; and incentives. Wellness and consumer engagement are integrated into the health plan offering. The plan consists of tools that assist members in positively changing their lifestyle habits and rewarding those individuals that have proven their commitment to their pursuit of wellness and reaching their optimal level of health. Members that participate in and complete healthy activities may be eligible for an enhanced plan with lower member costs.

In an example embodiment, a computerized system and method comprises an enrollment process that serves a starting point for determining a consumer's wellness, identifying tools and resources to increase the consumer's wellness, and applying incentives to encourage participation in wellness activities. Consumer enrollment data is stored in a shared repository that is also used to track the consumer's participation in wellness activities and to determine eligibility for enhanced plan benefits. Enhanced plan benefits may include increased and/or expanded coverage for such items as primary care and specialty care office visits, and/or reduced co-pays for office visits and emergency room or urgent care visits. Other aspects of the benefit plan may be modified once a member qualifies for enhanced plan benefits.

Health benefits for qualified members may be enhanced during the plan year. Upon completion of wellness programs and activities, an effective date for the enhanced benefits is set (e.g., the first day of the month following confirmation of the member's eligibility). Participation data is tracked in a computerized system and a “trigger file” is used to identify to a computerized health plan administration system the members that are eligible for enhanced benefits.

### BRIEF DESCRIPTION OF THE DRAWINGS

FIG. 1 is a flow diagram illustrating member experience according to an example embodiment;

FIG. 2 is a systems flow diagram according to an example embodiment;

FIG. 3 is a member move and reporting flow diagram according to an example embodiment; and

FIGS. 4-12 are sample screens for a member portal according to an example embodiment.

### DETAILED DESCRIPTION

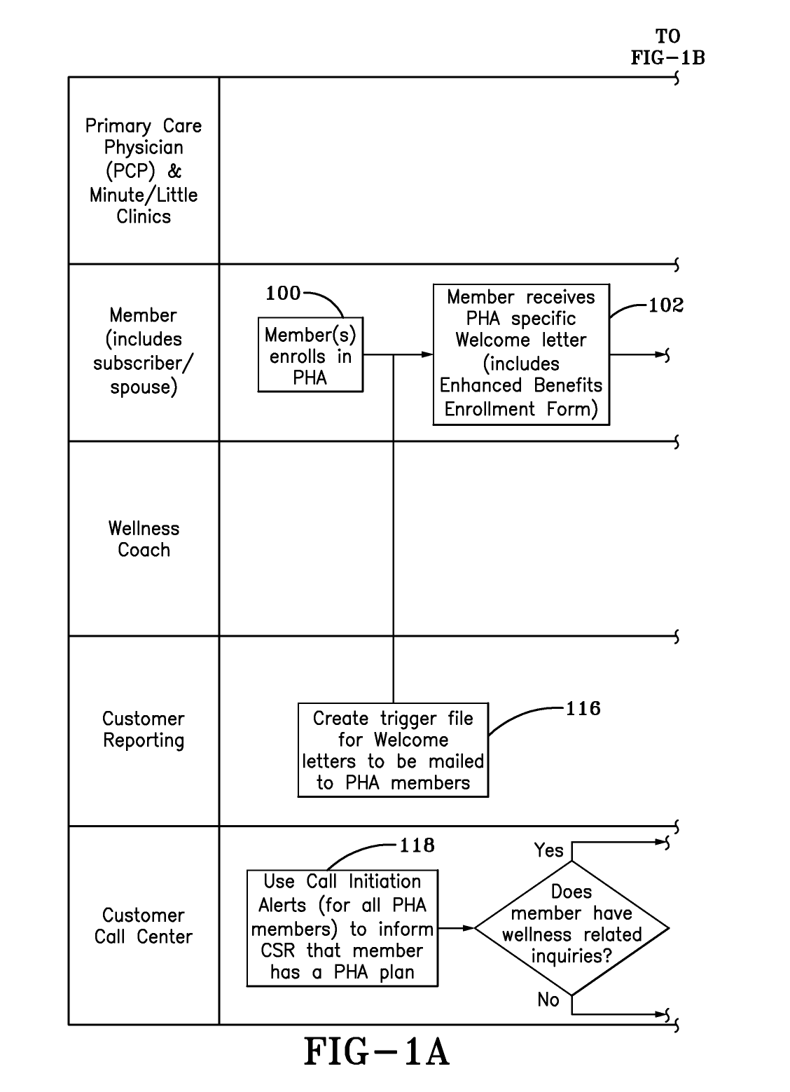

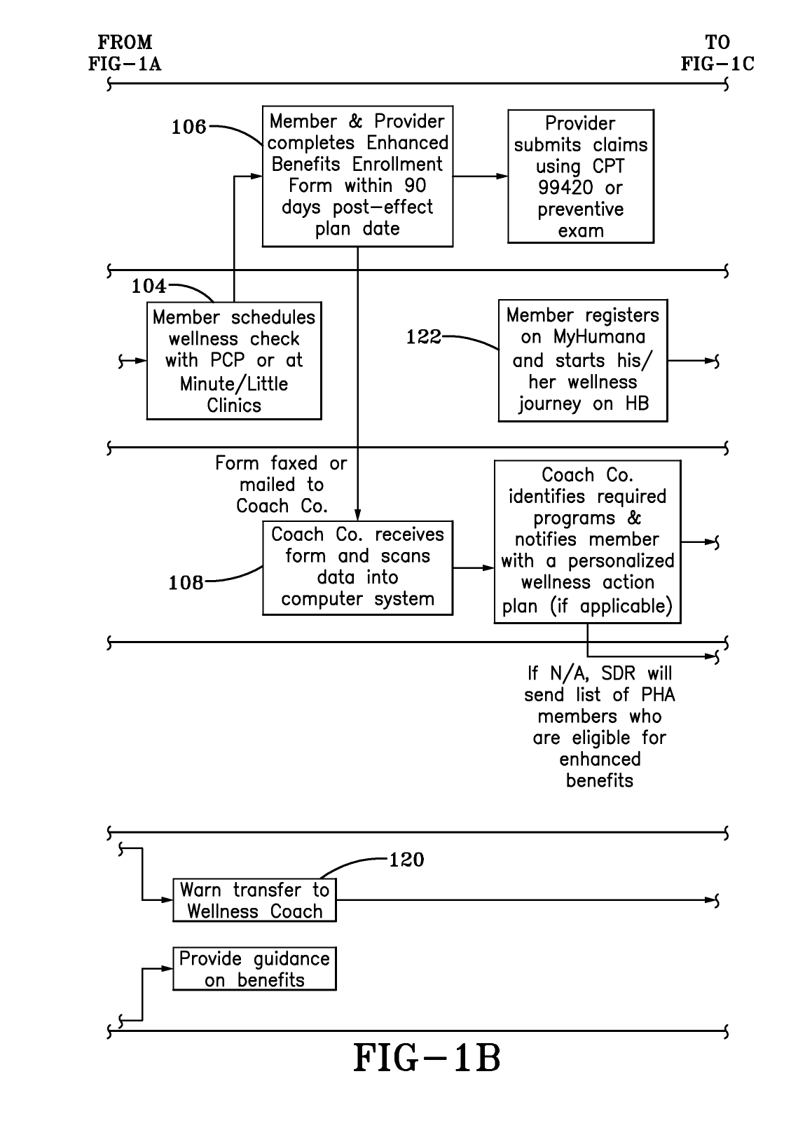

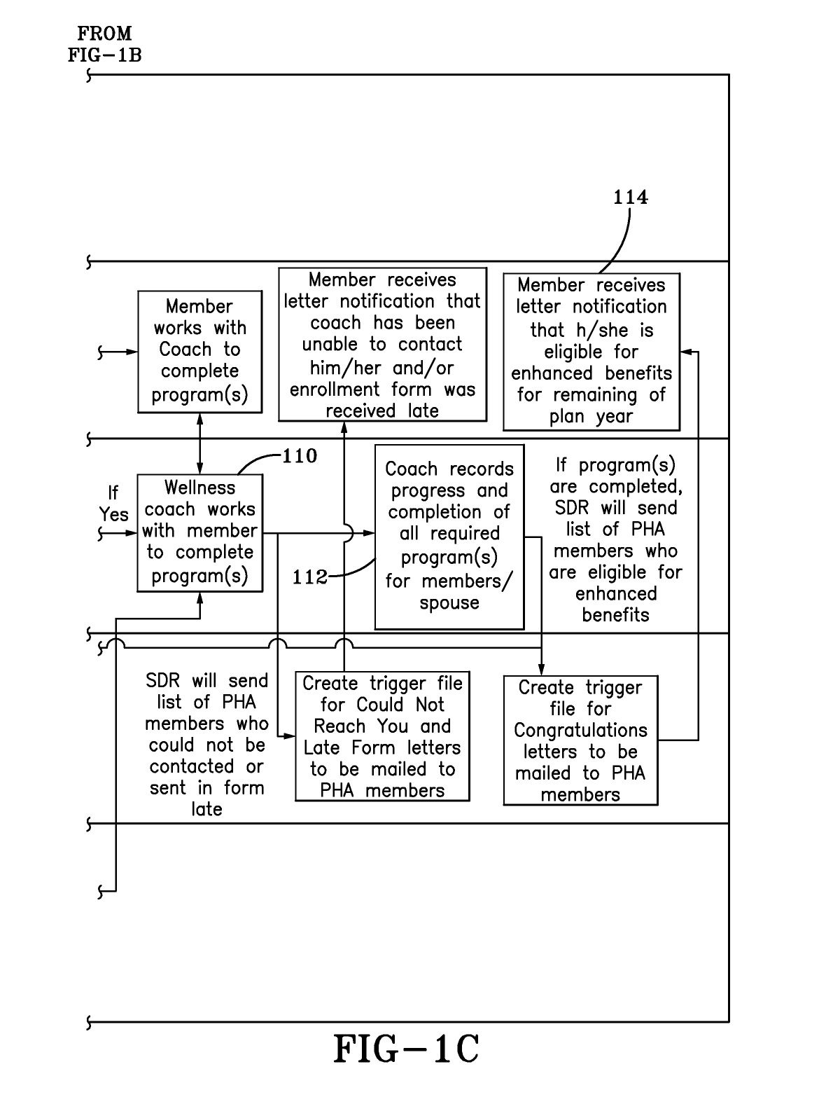

Referring to FIG. 1, a flow diagram illustrating member experience according to an example embodiment is shown. In an example embodiment, individual members are initially enrolled using a standard initial enrollment process 100. Enrollment results in creation of a trigger file 116 identifying members that should receive “welcome” letters. Each health plan subscriber receives a health plan specific welcome letter 102 that not only welcomes the member to the health plan and highlights its value proposition, but also provides instructions on how to take advantage of plan features 116. Subscribers (and spouse, if applicable) are further asked to complete an enhanced benefits enrollment form 104 included in the letter. The subscriber (and spouse, if applicable) completes an enhanced benefits enrollment form with his/her primary care physician or a clinic provider 104 and either fax or mail the completed form to Humana within 90 days of his/her post-plan effective date 106.

In an example embodiment, the health plan concentrates on three high impact risk factor measurements:
1) Tobacco;
2) Body Mass Index (BMI); and
3) Weight/physical activity.

These measurements are incorporated into an example embodiment of the plan design because there is a correlation between individuals controlling the outcome of these risk factors and developing a chronic condition. In an example embodiment, the form comprises the following details.

TABLE 2
Form Details

| | |
|---|---|
| Member | You have two ways to complete this enrollment form. You can either schedule a |
| Instructions: | preventive services visit with your health care practitioner or go to a convenient |
| | care clinic (such as clinics found in your local pharmacy or grocery store). |
| | Complete the member information and lifestyle behavior questions sections. The |
| | lifestyle behavior questions section should be completed with your health care |
| | practitioner. Sign and date this enrollment form in the space provided. Mail or fax |
| | a copy of the completed enrollment form to wellness company. If your health plan |
| | covers your spouse or partner, he or she must complete and sign his/her own |
| | enhanced benefits enrollment form. |
| Health Care | This enrollment form is the first step for the member to enroll in enhanced |
| Practitioner | benefits in his/her medical plan. Complete the health care practitioner information |
| Instructions | and lifestyle behavior questions sections and sign this enrollment form. Give a |
| | copy to the member and keep one for your records. |
| Lifestyle Behavior | Within the past six months, have you used at any time any tobacco products |
| Questions - | (including, but not limited to, cigarettes, cigars, pipe smoking, chewing tobacco or |
| Tobacco | any other smokeless tobacco product)? Yes or No? |
| (Completed by | |
| Member) | |
| Lifestyle Behavior | Exercise guidelines: Within the past six months have you exercised moderately |
| Questions - | by walking, jogging, low impact aerobics, or similar moderate activity or |
| Physical Activity | vigorously by running, swimming laps, peddling a bike strenuously, or similar |
| (Completed by | vigorous activity: |
| Member) | Less than 150 minutes per week of moderate activity? |
| | At least 150 minutes per week of moderate and/or vigorous activity? |
| | At least 75 minutes per week of vigorous activity? |
| Lifestyle Behavior | Please complete with the member's height, weight and BMI. |
| Questions - Body | Height: Weight: BMI: |
| Mass Index | (To calculate BMI, multiply weight in pounds by 703, then divide by height in |
| (Completed by | inches squared.) |
| Health Practitioner) | |

Once these measurements are collected on the enhanced benefits enrollment form and submitted for analysis, a personalized wellness action plan is developed to incorporate the following wellness-based activities as applicable:
1) Smoking cessation (if the member is a smoker);
2) Weight management (if the BMI values are not within the national standard guidelines); and
3) Physical activity as applicable.

The member is also assigned a wellness coach 108 who assists in setting personal goals and advancing the member toward a healthier lifestyle. The wellness coach may receive a copy of the member's enhanced benefits enrollment form to assist the coach in identifying programs and activities suitable for the member's goals and abilities. As applicable, the coach develops for the member a personalized wellness action plan. As members complete programs and/or progress toward their goals 110, they may become eligible for enhanced benefits 112. In an example embodiment, members (subscriber and spouse, if applicable) that meet eligibility requirements are notified that they are eligible for and enrolled in an enhanced benefit plan for the remainder of the plan year 114. Throughout the plan year, members receive communications on lifestyle changes and medical care usage.

To facilitate the process of assigning wellness coaches to enhanced benefit plan members, some members may learn about working with a wellness coach during a conversation with a customer service representative 118. The member's contact and other information may be provided to a wellness coach who then works with the member to develop a customized program 120. Finally, members may connect with a wellness coach by registering at a web site 122.

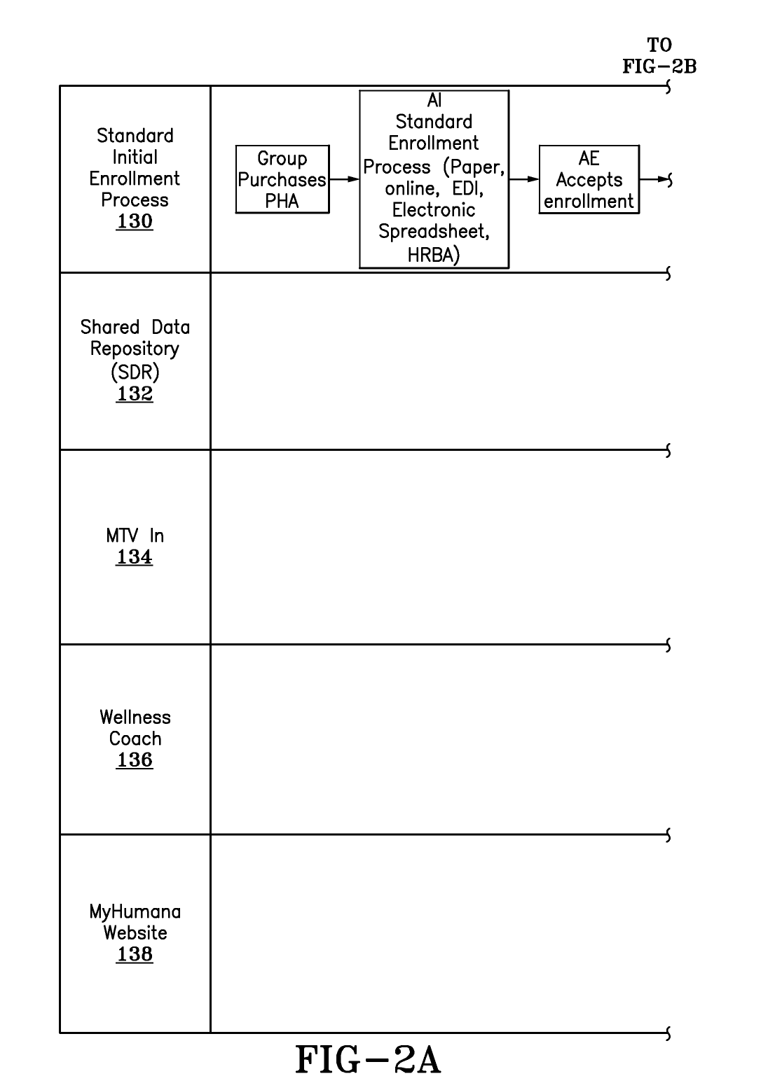

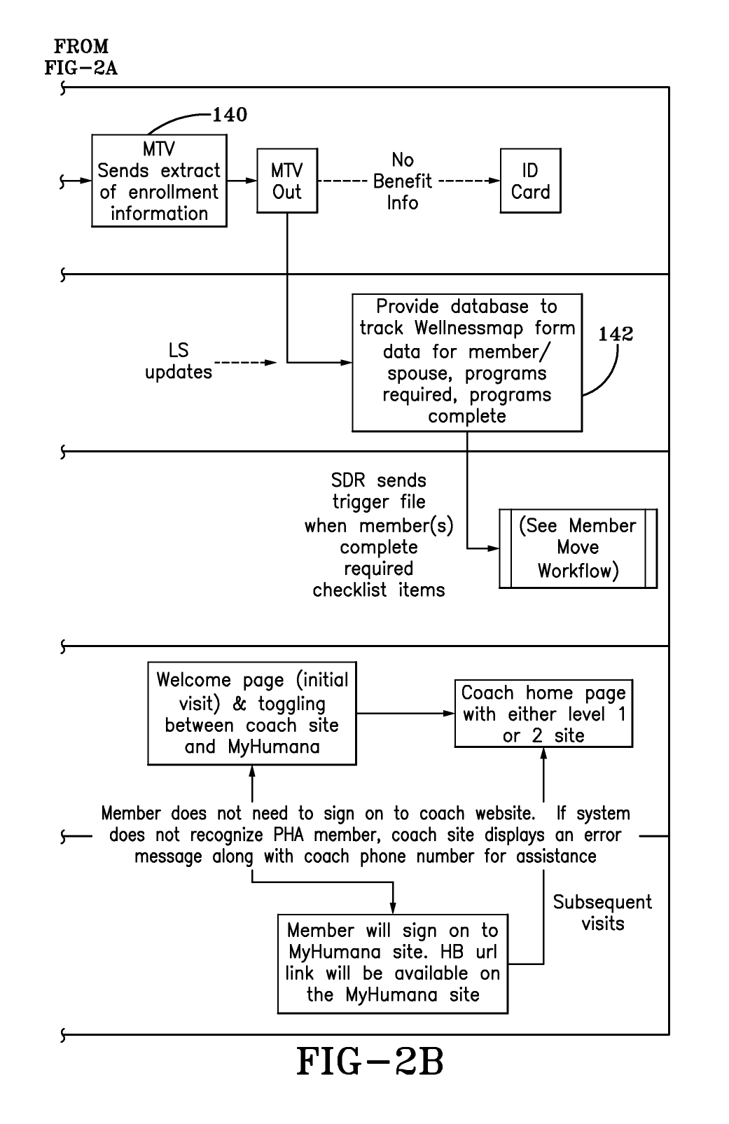

Referring to FIG. 2, a systems flow diagram according to an example embodiment is shown. Initially, members complete a standard enrollment process 130. Enrollment information for each member is obtained and entered in health insurance administration computer system 140. Members may be issued identification cards for use in obtaining benefits and participating in the wellness programs. Rather than issuing a traditional health benefits identification card that lists office visit, emergency room, co-pays, etc., there are no co-pay benefits listed on the card. As a result, the benefits may change during the plan year without requiring the health plan administrator to issue new cards to members that are entitled to enhanced benefits. A specific enhanced benefit plan welcome letter and enhanced benefits enrollment form(s) is (are) sent to the subscriber upon completion of the enrollment process.

Enrollment data is entered in a shared repository 132 so that each subscriber's (and spouse, if applicable) compliance with plan and wellness program requirements may be tracked 142. Prior to participation in wellness programs and activities, subscribers (and spouse, if applicable) complete an enhanced benefits enrollment form(s) that assist wellness coaches with identifying member needs and developing customized programs. In an example embodiment, subscribers (and spouse, if applicable) may be required to complete an enhanced benefits enrollment form(s) within a specified period of time (e.g., 90 days post-plan effective date). The member (and spouse, if applicable) work with a provider (e.g., primary care physician, clinic, etc.) to complete the enhanced benefits enrollment form and obtain measurements in key areas. The provider may be asked to submit a wellness check claim to the health plan administrator for processing of a claim related to the wellness check. The form is returned to the wellness coach (e.g., by fax or mail).

The wellness coach reviews the enhanced benefits enrollment form and develops a personalized wellness action plan for the subscriber and spouse (if applicable). Subscribers (and spouse, if applicable) are stratified into risk corridors based on data collected from the enhanced benefits enrollment form. Subscribers (and spouse, if applicable) work with a wellness coach to set personalized goals and enroll in applicable wellness programs and activities. As members complete applicable programs and activities, the wellness coach updates member profile data and indicates that the members have successfully completed the programs and activities.

Information related to wellness programs and activities may be accessible through a wellness coach portal 136 or benefits plan portal 138. Participation in wellness programs and activities is tracked at the shared data repository 132. A “trigger file” is transmitted from the shared data repository 132 to the health insurance administration system 134. For members that have successfully completed programs and activities and are eligible for enhanced benefits, changes to the member's plan benefits may be made at the health insurance administration system. Upon successful submission of data for risk factor measurements through the enhanced benefits enrollment form and completion of wellness based programs and activities, the subscriber, spouse (if applicable) and dependents (if applicable) enrolled in the subscriber's health plan are moved to an enhanced health plan for the remainder of the plan year. In an example embodiment, the move to an enhanced level of benefits is effective on the first day of the following month. Throughout this plan year, members receive communications on lifestyle changes and medical care utilization.

The following table illustrates plan features for a standard plan and enhanced according to an example embodiment. Plan features and details may be varied in many ways to meet the needs of employers and other plan sponsors. Data elements (e.g., deductibles, co-pays, percentages, levels of coverage, etc.) related to the standard as well as enhanced plans may be stored in a database at a computerized health insurance administration system so that claims submitted by members of the plan are processed according to the level of benefits for which the member is eligible.

TABLE 1
Plan Offering

| Plan Features | Standard Plan | Enhanced Plan |
|---|---|---|
| PBA | $500 | $500 |
| Coinsurance | 70/50 | 90/60 |
| Office Visit | $35 Primary Care | $25 Primary Care |
| Co-pay | Physician/$75 | Physician/$55 |
| | Specialist | Specialist |
| Preventive | Covered in Full | Covered in Full |
| Services | | |
| ER | $250 co-pay per visit | $150 co-pay per visit |
| | then 100% | then 100% |
| Urgent Care | $100 co-pay per visit | $75 co-pay per visit |
| Physician | | |
| Rx4 | 10/40/70/25% | 10/40/70/25% |
| | ($0 or $250 FED | ($0 or $250 FED |
| | applies to levels 2-4) | applies to levels 2-4) |
| Wellness | No | Yes |
| Activities | | |

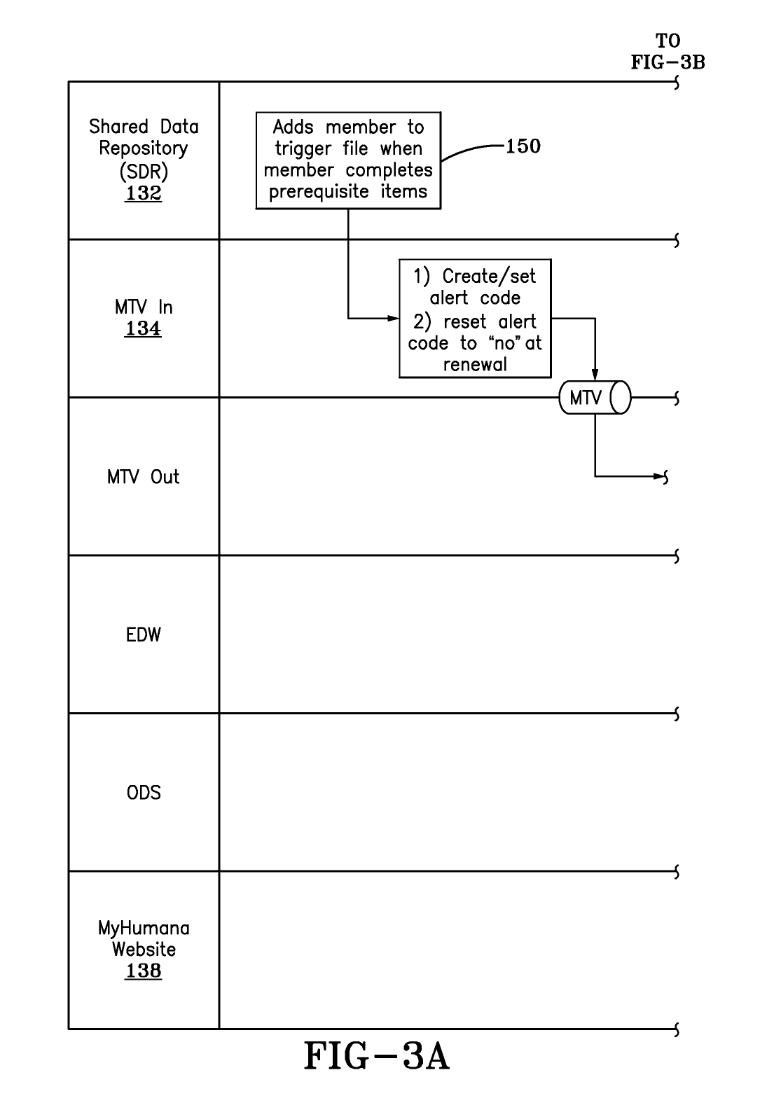

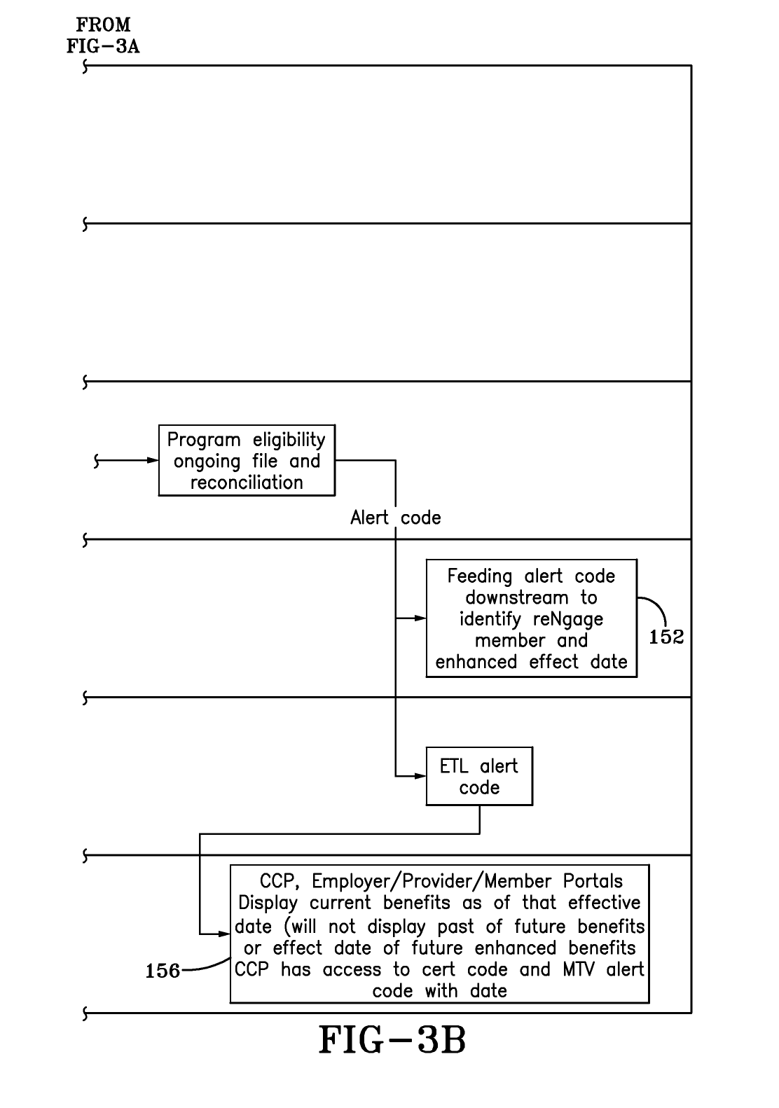

Referring to FIG. 3, a member move and reporting flow diagram according to an example embodiment is shown. Member progress is tracked in the shared data repository 132. Members are added to a trigger file when they complete prerequisite items for the enhanced benefit plan 150. The trigger file is communicated to the health insurance administration system 134 so that elements of the member's benefit plan may be modified. In an example embodiment, changes in program eligibility, including an effective date, are communicated to other computerized systems as needed so that the member can view information related to the enhanced benefits and take advantage of them. In an example embodiment, changes are communicated using an alert code 152. Various portals 138 such as a customer care portal, an employer portal, and a provider portal may provide users with access to data related to the member's enhanced benefits so that the users provide services that match the member's benefit level 156.

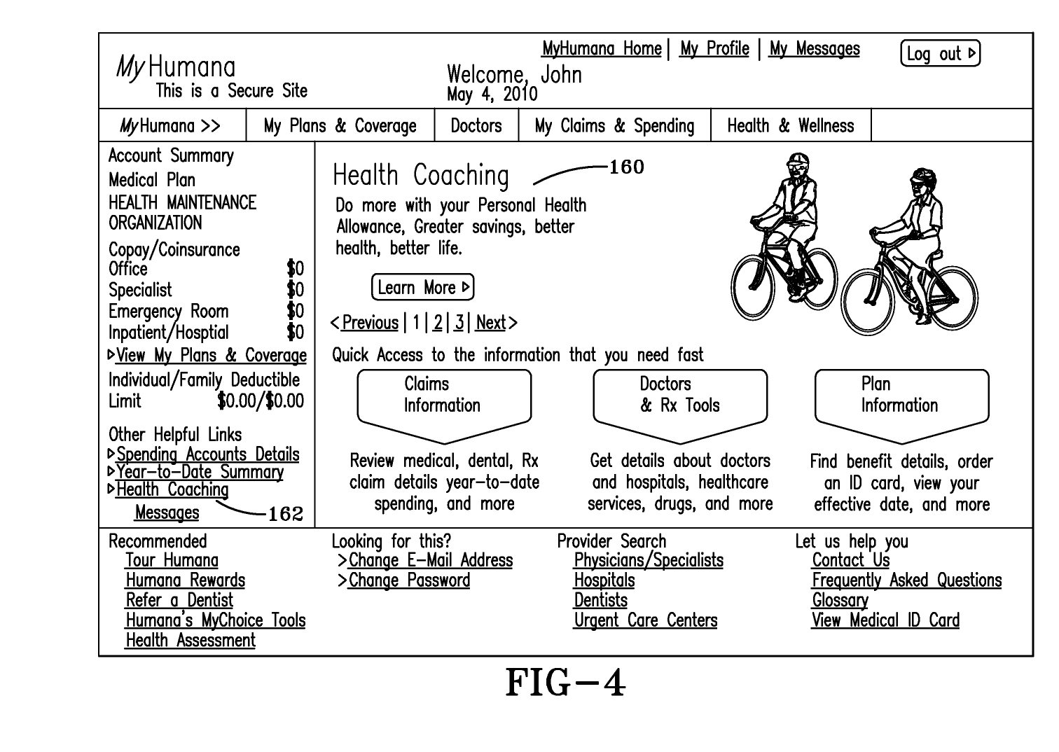

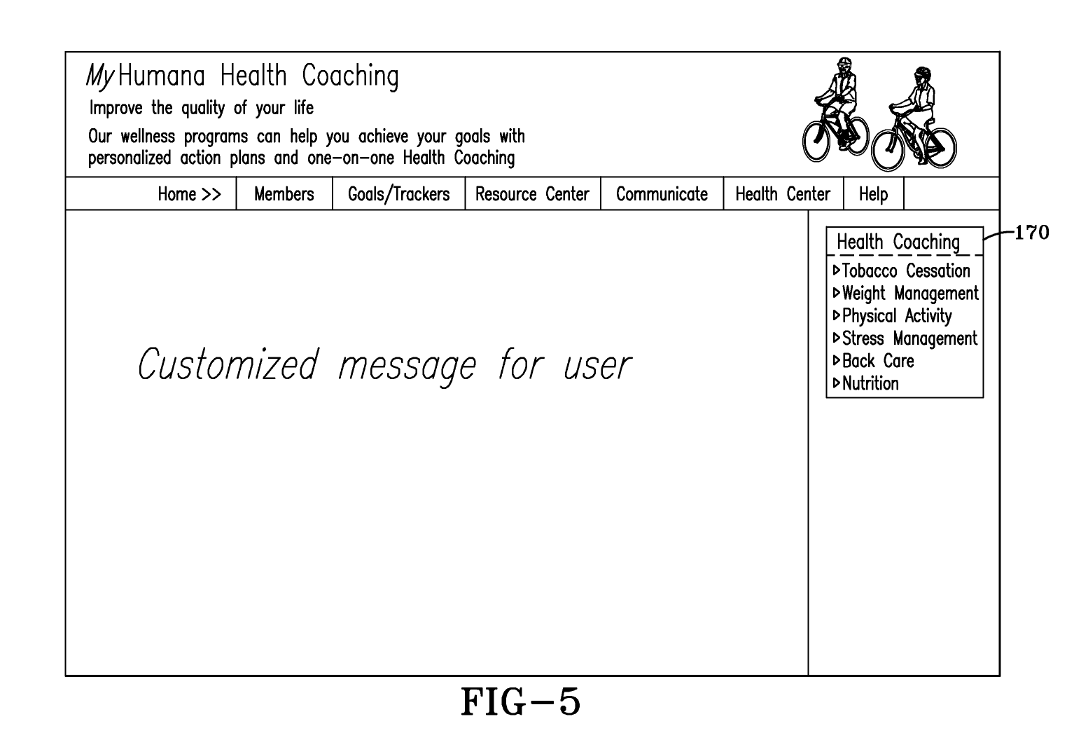

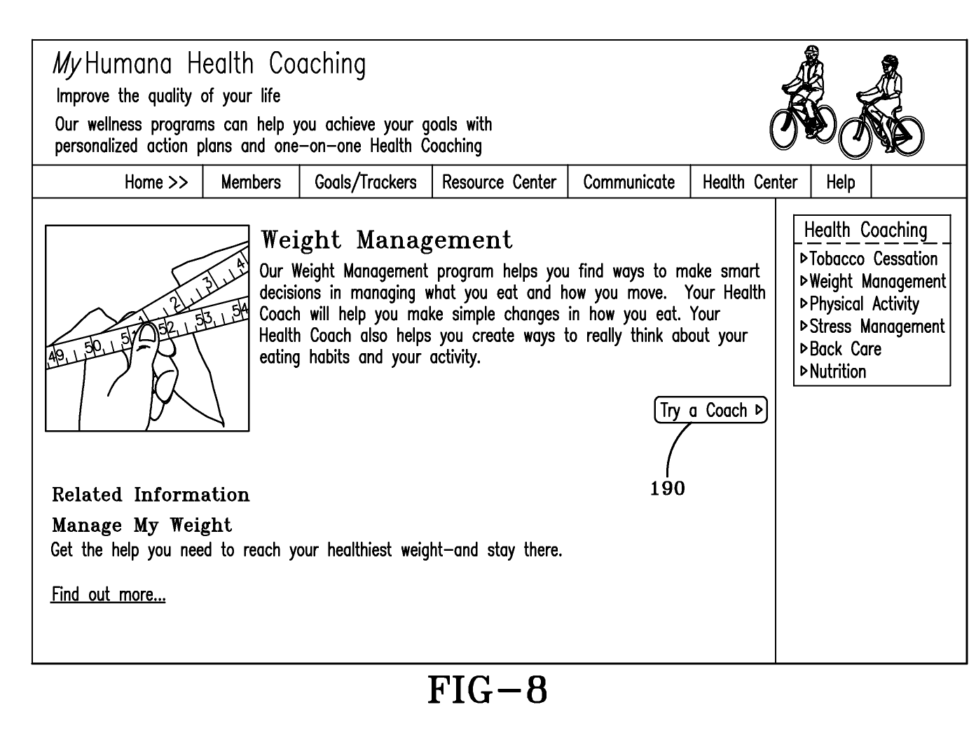

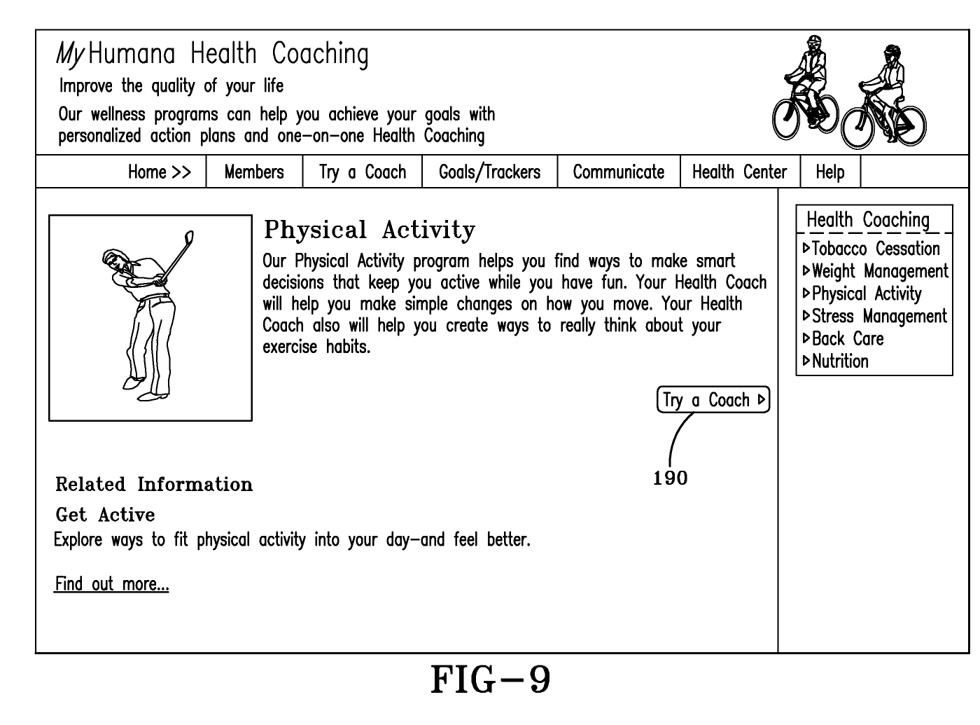

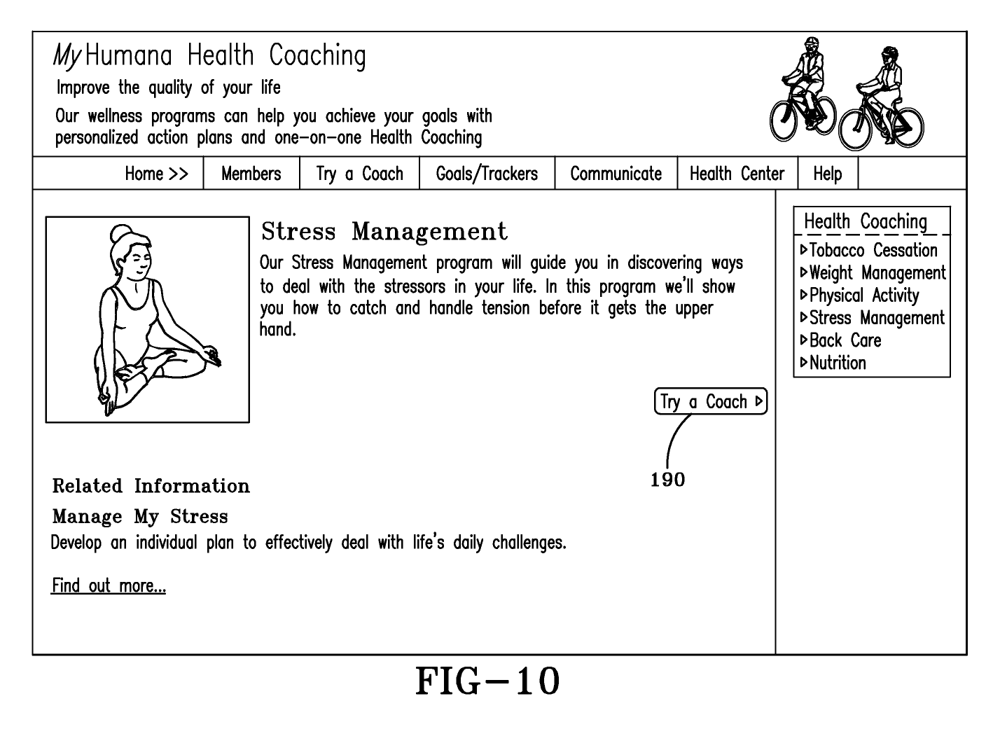

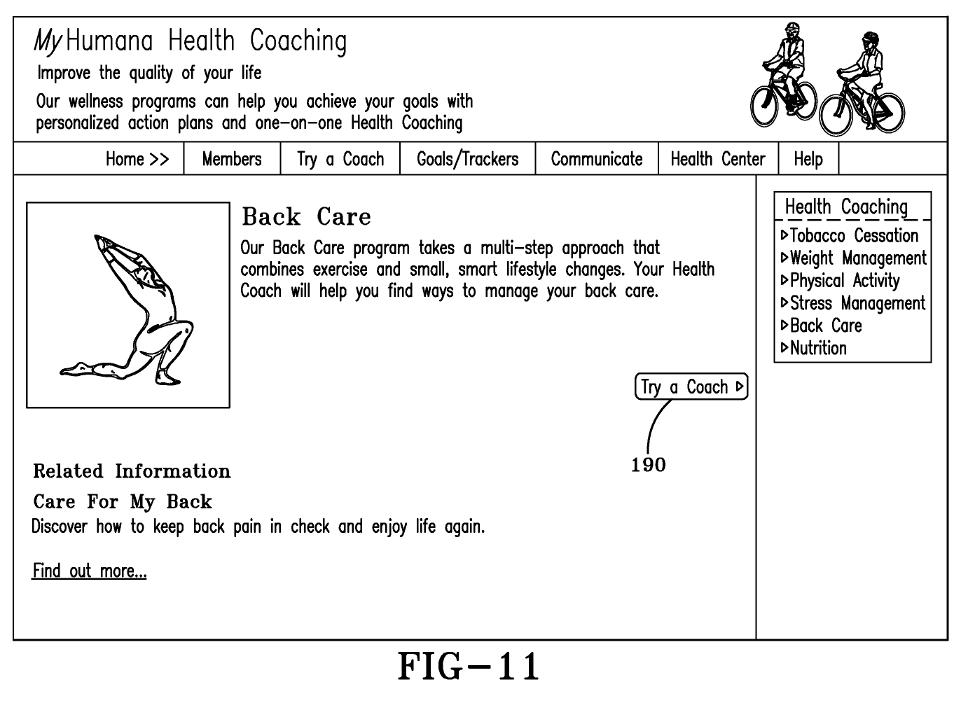

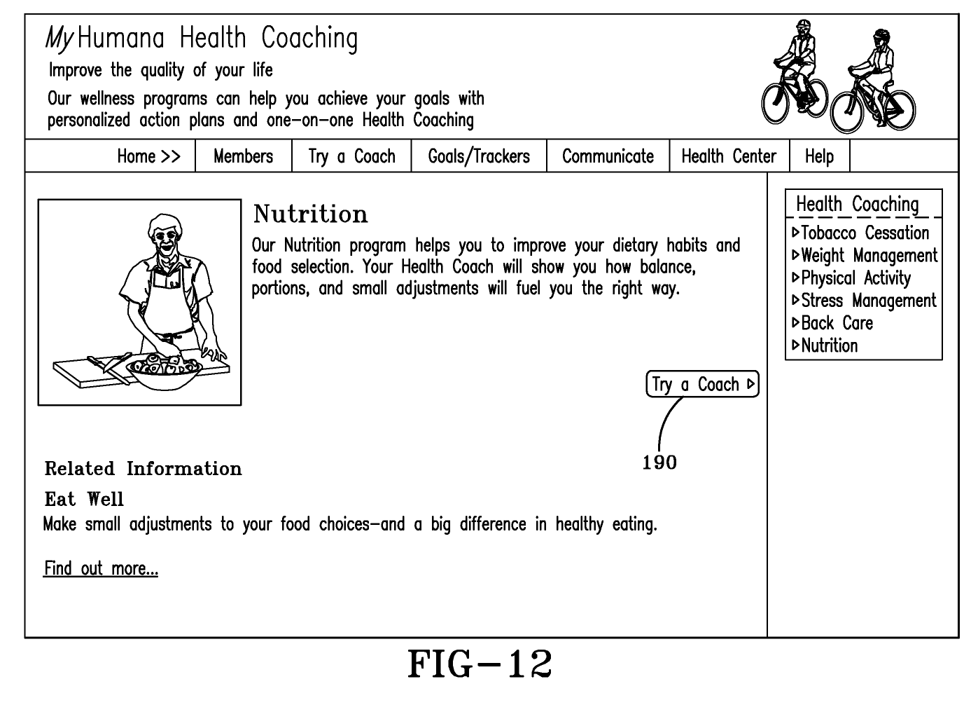

Referring to FIGS. 4-12, sample screens for a member portal according to an example embodiment are shown. Referring to FIG. 4, a sample landing page for a member portal according to an example embodiment is shown. In an example embodiment, a member enrolled in the enhanced benefit plan may learn more about the various wellness programs by accessing a “health coaching” option 160, 162. Referring to FIG. 5, a sample health coaching page for a member portal according to an example embodiment is shown. From this page, a member may select one of several health coaching options 170 in areas such as tobacco cessation, weight management, physical activity, stress management, back care, and nutrition. Selection of a link from the list of options may redirect the browser to a health coaching page for the selected option.

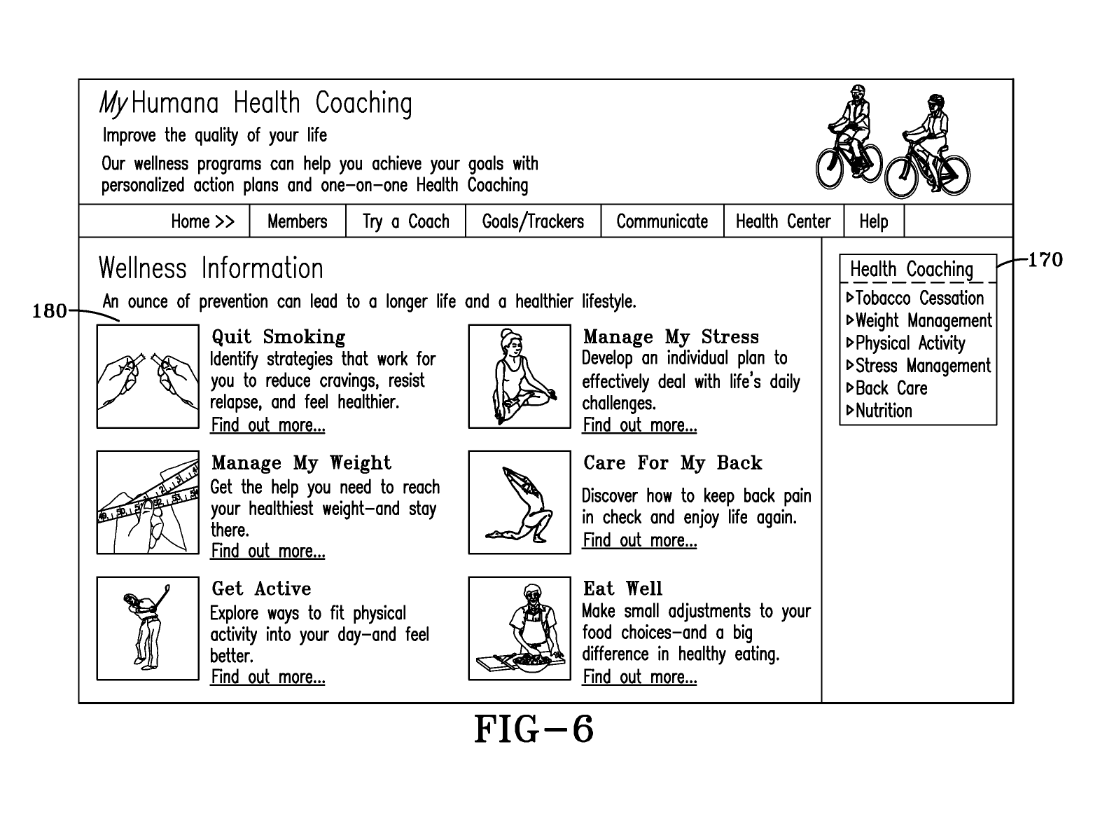

Referring to FIG. 6, a sample wellness information page according to an example embodiment is shown. In an example embodiment, the wellness information page presents options for various wellness programs and activities 180 such as smoking cessation, weight management, physical activity, stress management, back care, and eating well. Selection of an option from the page of options may redirect the browser to a detail page for the selected option.

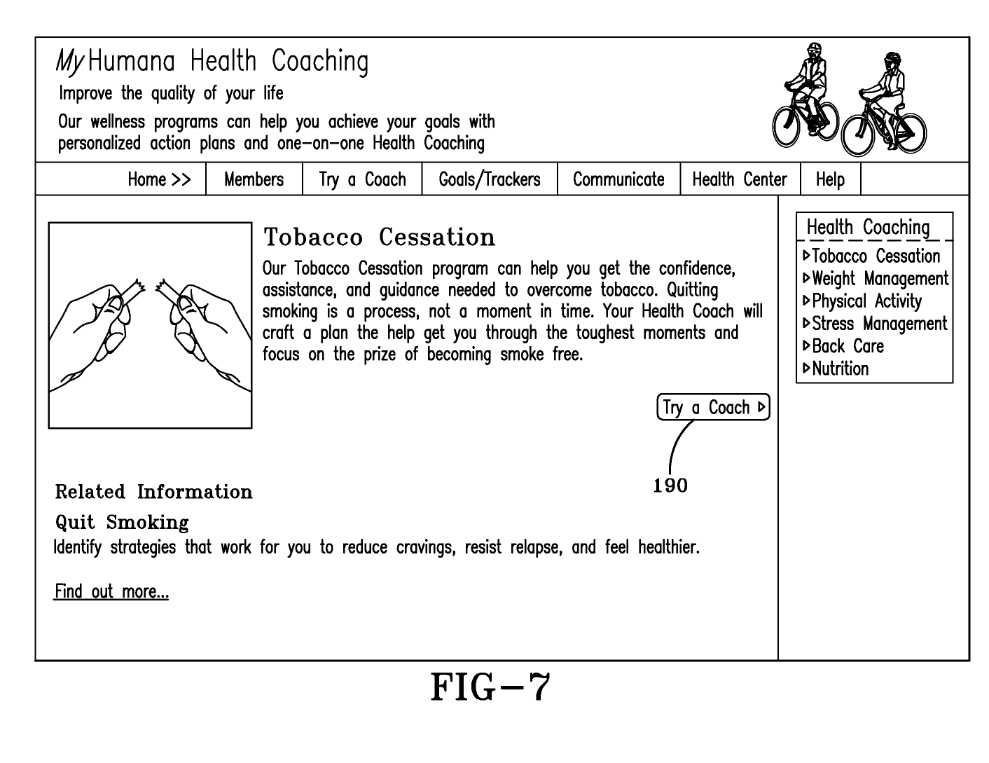

Referring to FIG. 7 a sample tobacco cessation page according to an example embodiment is shown. In an example embodiment, the page presents an overview of a tobacco cessation program and provides an option for contacting a coach 190 that can work with the member to develop a personalized action plan. Similar pages as shown in FIGS. 8 (weight management), 9 (physical activity), 10 (stress management), 11 (back care), and 12 (nutrition) may be developed.

The present disclosure describes a computerized system and method for providing incentives to members of a health benefits plan to engage in healthy behaviors. Members that enroll in a standard health plan, complete a wellness check, and reach personalized goals established according to the results of the wellness check become eligible for an enhanced benefit plan. In an example embodiment, co-pays are reduced under the enhanced benefit plan. In addition, the member is provided with communications on lifestyle changes and other information that is helpful in establishing and maintaining a healthy lifestyle.

While certain embodiments of the present invention are described in detail above, the scope of the invention is not to be considered limited by such disclosure, and modifications are possible without departing from the spirit of the invention as evidenced by the claims. For example, standard as well as enhanced benefit options and levels may be varied and fall within the scope of the claimed invention. In addition, technical details related to tracking progress toward personalized goals and communicating information about eligible members may be varied and fall within the scope of the claimed invention. One skilled in the art would recognize that such modifications are possible without departing from the scope of the claimed invention.

1. A computerized method for providing enhanced health benefits to a plurality of members of a health plan comprising:
(a) storing in a plan database data elements for a standard health plan;
(b) storing in said plan database data elements for an enhanced health plan;
(c) receiving at a health plan administration server standard health plan enrollment data for a plurality of members enrolled in said standard health plan;
(d) receiving at a shared data repository enhanced health plan enrollment data for at least one member, said data responsive to an offer presented to all of said plurality of members to participate in said enhanced health plan;
(e) in response to receiving said enhanced plan enrollment data, identifying for said member electing to participate in said enhanced health plan at least one health activity for determining said member's eligibility for enhanced benefits under said enhanced health plan;
(f) receiving at said shared data repository an indicator that said member has completed said at least one health activity;
(g) updating at said shared data repository said enhanced health plan enrollment data to indicate said member is eligible for enhanced benefits under said enhanced benefit plan;
(h) adding identifying data for said member to a trigger file at said shared data repository identifying members completing prerequisites for said enhanced health plan;
(i) transmitting said trigger file from said shared data repository to said health plan administration server;
(j) transmitting from said health plan administration server to a plurality of portals an alert code indicating said member is eligible for said enhanced benefits; and
(k) processing at said health plan administration server an insurance claim for said member according to said enhanced benefits of said enhanced benefit plan.

2. The computerized method of claim 1 wherein said enhanced health plan comprises a member enhanced plan co-pay amount that is lower than a member standard plan co-pay amount.

3. The computerized method of claim 2 wherein said enhanced plan co-pay is selected from the group consisting of:
office visit co-pay; urgent care physician visit; and emergency room visit.

4. The computerized method of claim 1 wherein said enhanced health plan comprises a member benefit level that is higher than said member benefit level in said standard health plan.

5. The computerized method of claim 2 wherein said standard plan co-pay is selected from the group consisting of:
office visit co-pay; urgent care physician visit; and emergency room visit.

6. The computerized method of claim 1 wherein said enhanced benefit plan covers wellness activities.

7. The computerized method of claim 1 wherein receiving at said shared data repository an indicator that said member has completed said at least one health activity comprises receiving an indicator said member has completed at least one personalized goal for a wellness program.

8. A computerized method for providing enhanced health benefits comprising:
(a) storing in a plan database data elements for a standard health plan;
(b) storing in said plan database data elements for an enhanced health plan;
(c) receiving at a health administration plan server standard health plan enrollment data for a member enrolled in said standard health plan;
(d) receiving at a shared data repository enhanced health plan enrollment data for at least one member, said data responsive to an offer presented to all of said plurality of members to participate in said enhanced health plan;
(e) receiving at said shared data repository an indicator that said member is eligible for said enhanced health plan, said indicator received after:
(1) said member completes a wellness check; and
(2) said member completes at least one wellness program selected for said member according to results of said wellness check;
(f) updating at said shared data repository said member enrollment data to indicate said member is eligible for enhanced benefits under said enhanced benefit plan;
(g) adding identifying data for said member to a trigger file at said shared data repository identifying members completing prerequisites for said enhanced health plan;
(h) transmitting said trigger file from said shared data repository to said health plan administration server;
(i) transmitting from said health plan administration server to a plurality of portals an alert code indicating said member is eligible for said enhanced benefits; and
(j) processing at said health plan administration server an insurance claim for said member according to said enhanced benefits under said enhanced benefit plan.

9. The computerized method of claim 8 wherein said enhanced health plan comprises a member enhanced plan co-pay amount that is lower than a member standard plan co-pay amount.

10. The computerized method of claim 9 wherein said enhanced plan co-pay is selected from the group consisting of:
office visit co-pay; urgent care physician; and emergency room visit.

11. The computerized method of claim 8 wherein said enhanced health plan comprises a member benefit level that is higher than said member benefit level in said standard health plan.

12. The computerized method of claim 9 wherein said standard plan co-pay is selected from the group consisting of:
office visit co-pay; urgent care facility visit; and emergency room visit.

13. The computerized method of claim 8 wherein said enhanced benefit plan covers wellness activities.

14. A computerized system for providing enhanced health benefits comprising:
(a) a computerized plan database for storing:
(1) standard health plan data elements;
(2) enhanced health plan data elements;
(b) a computerized member database storing member data;
(c) a first computer server executing instructions to:
(1) receive at said server standard health plan enrollment data for a member enrolled in said standard health plan;
(2) receive at said server enhanced plan enrollment data for at least one member, said data responsive to an offer presented to all of said plurality of members to participate in said enhanced health plan;
(3) receive at said server an indicator that said member is eligible for said enhanced health plan based on completion of a health activity identified based on said enhanced plan enrollment data;
(4) update said member enrollment data in said member database to indicate said member is eligible for enhanced benefits under said enhanced benefit plan;
(5) add identifying data for said member to a trigger file identifying members completing prerequisites for said enhanced health plan; and
(d) a health plan administration server executing instructions to:
(1) receive from said first computer server said trigger file;
(2) transmit from said health plan administration server to a plurality of portals an alert code indicating said member is eligible for said enhanced benefits; and
(3) process at said health plan administration server an insurance claim for said member according to said enhanced benefits of said enhanced benefit plan.

15. The computerized system of claim 14 wherein said enhanced health plan comprises a member enhanced plan co-pay amount that is lower than a member standard plan co-pay amount.

16. The computerized system of claim 15 wherein said enhanced plan co-pay is selected from the group consisting of:
office visit co-pay; urgent care physician visit; and emergency room visit.

17. The computerized system of claim 14 wherein said enhanced health plan comprises a member benefit level that is higher than said member benefit level in said standard health plan.

18. The computerized system of claim 15 wherein said standard plan co-pay is selected from the group consisting of:
office visit co-pay; urgent care physician visit; and emergency room visit.

19. The computerized system of claim 14 wherein said enhanced benefit plan covers wellness activities.

20. The computerized system of claim 14 wherein said indicator that said member is eligible for said enhanced health plan is an indicator received after said member reaches at least one personalized goal for a wellness program.
